(19) United States
(12) Patent Application Publication
(10) Pub. No.: US 2015/0020612 A1
(43) Pub. Date: Jan. 22, 2015

(54) METHOD AND MEANS TO MONITOR SEEDER ROW UNIT DOWNFORCE

(71) Applicant: AG LEADER TECHNOLOGY, Ames, IA (US)

(72) Inventors: Ryan Witt, Ames, IA (US); Scott Eichorn, Ames, IA (US)

(21) Appl. No.: 14/331,551

(22) Filed: Jul. 15, 2014

Related U.S. Application Data
(60) Provisional application No. 61/847,151, filed on Jul. 17, 2013.

(51) Int. Cl. G01L 5/00

(52) U.S. Cl. CPC G01L 5/0061
USPC 73/862.381

(57) ABSTRACT

A method of monitoring forces in a planter includes measuring compressive force between contacting surfaces of the depth regulation member. The measuring may be performed with a sensor such as a piezoresistive sensor. An apparatus for monitoring force on a planter includes a sensor for measuring compressive force between contacting surfaces of a depth regulation member of the planter.

### CROSS REFERENCE TO RELATED APPLICATIONS

This application claims priority under 35 U.S.C. §119 to provisional applications U.S. Ser. No. 61/847,151 filed Jul. 17, 2013, herein incorporated by reference in its entirety.

### BACKGROUND OF THE INVENTION

It is common knowledge to growers that maintaining the load carried by the gauge wheels of a conventional row-crop planter within a specified range is desirable to promote uniform emergence, correct furrow formation, and proper root growth.

One way to maintain proper load on the gauge wheels is to adjust the amount of additional load applied to the planter. Common methods of load application include pneumatic and hydraulics actuators. These loads are adjusted based on input from load sensors mounted in a manner allowing them to monitor the load applied to the gauge wheels, such as the mechanical linkages used to adjust the planting depth. This process has been indicated previously in U.S. Pat. Nos. 6,389,999 and 6,701,857, both of which are hereby incorporated by reference. The wheel load sensors envisioned in the patents utilized strain-gauged load cells or pressure transducers.

A number of systems are now commercially available using strain-gauge load sensors to monitor the gauge wheel load of selected planter rows, such a John Deere's SeedStar XP, Precision Planting's 20/20 Airforce, and Ag Leaders Hydraulic Down Force system. An example of a practical strain gauge load sensor is presented in patent application 2010/0180695 A1, hereby incorporated by reference.

There are a number of challenges with using a strain gauge load sensor. The strain gauges are fragile and require very precise installation under very clean conditions to assure a proper bond to the structure. This fragility impacts the long term reliability under real-world agricultural use conditions. The precision of installation results in a costly sensor. This prevents the introduction of gauge wheel load monitoring on all planter rows, instead of selected rows on current commercial models.

What is needed is a cost effective method and means for load monitoring of additional planter rows.

### SUMMARY OF THE INVENTION

Therefore, it is a primary object, feature, or advantage of the present invention to improve over the state of the art.

It is a further object, feature, or advantage of the present invention to provide a cost effective method and means of load monitoring on a row unit.

It is a still further object, feature, or advantage of the present invention to provide a method and means of load monitoring on a row unit that permits easier installation than that associated with strain gage load sensors.

Another object, feature, or advantage of the present invention is to provide a method and means of load monitoring that allows for any number of different row units to be monitored on a planter.

Yet another object, feature, or advantage of the present invention is to provide for monitoring the force between contact surfaces of depth regulating members.

A further object, feature, or advantage of the present invention is to use a piezoresistive force sensor as a means of sensing load on a depth regulation member.

A still further object, feature, or advantage of the present invention is to provide the load in a transverse fashion to the sensor face.

Another object, feature, or advantage of the present invention is to prevent transmission of shear and bending forces to the load sensor.

Yet another object, feature, or advantage of the present invention is to restrict application of force to the active area of the load sensor.

A further object, feature, or advantage of the present invention is to provide for robust wiring for sensors to protect from physical and environmental damage.

A still further object, feature, or advantage of the present invention is to provide signal conditioning circuitry for transforming resistance change associated with a piezoresistive force sensor into a signal useable by electronic monitoring circuitry used in controlling row unit downforce.

According to one aspect, a method includes measuring compressive forces between contacting surfaces of a depth regulation member of the planter.

According to another aspect, an apparatus for monitoring force on a planter includes a sensor positioned on the planter for measuring compressive force between contacting surfaces of a depth regulation member of the planter.

According to another aspect, on a row-unit of an agricultural planter, an apparatus includes a sensor positioned for measuring compressive force between contacting surface of a depth regulation member of the row unit of the planter.

One or more of these and/or other objects, features, and advantages of the present invention will become apparent from the specification and claims that follow. No single embodiment need provide or meet each and every object, feature, or advantage as it is contemplated that different embodiments may have different objects, features, or advantages.

### BRIEF DESCRIPTION OF THE FIGURES

FIG. 1 illustrates a row planter.

FIG. 2 illustrates an example of sensor placement in planter linkages.

FIG. 3 illustrates an example of sensor placement in planter linkages.

FIG. 4 illustrates another example of a planter.

FIG. 5 illustrates a gauge wheel mount sensor.

FIG. 6 illustrates a depth level sensor.

FIG. 7 illustrates an example of a flexure force application guide.

FIG. 8 illustrates an example of a bearing force application guide.

FIG. 9 illustrates an example of a potted force application guide.

FIG. 10 illustrates an example of a scissor force application guide.

FIG. 11 illustrates an active face of a piezoresistive force sensor.

FIG. 12 illustrates a restricting force application to an active face.

FIG. 13 illustrates one example of a piezoresistive force sensor.

FIG. 14 illustrates one embodiment of amplification circuitry which may be used for signal conditioning.

### DETAILED DESCRIPTION

Methods, systems, and apparatus for load monitoring of planter rows are provided. The load monitoring shown and described herein may be accomplished using relatively low cost piezoresistive force sensors. Thus, a piezoresistive force sensor may be used to sense load on a depth regulation member. Because the piezoresistive force sensors are low-cost and because installation of the sensors does not involve the complexity associated with strain gage sensors, load monitoring can be provided for as many rows on a planter as desired, including every row if desired. Low-cost piezoresistive force sensors, such as the Flexiforce sensors produced by Tekscan, offer a solution to the need for load monitoring additional planter rows. These sensors change resistance in response to applied force, much like strain gauges change resistance in response to strain.

To date, the sensors suggested to monitor gauge wheel load have sensed bending or shear loads through the use of strain gauges or alternately by measuring the pressure imposed upon a hydraulic cylinder. The present invention provides for measurement of compressive force between contacting surfaces of the depth regulation members.

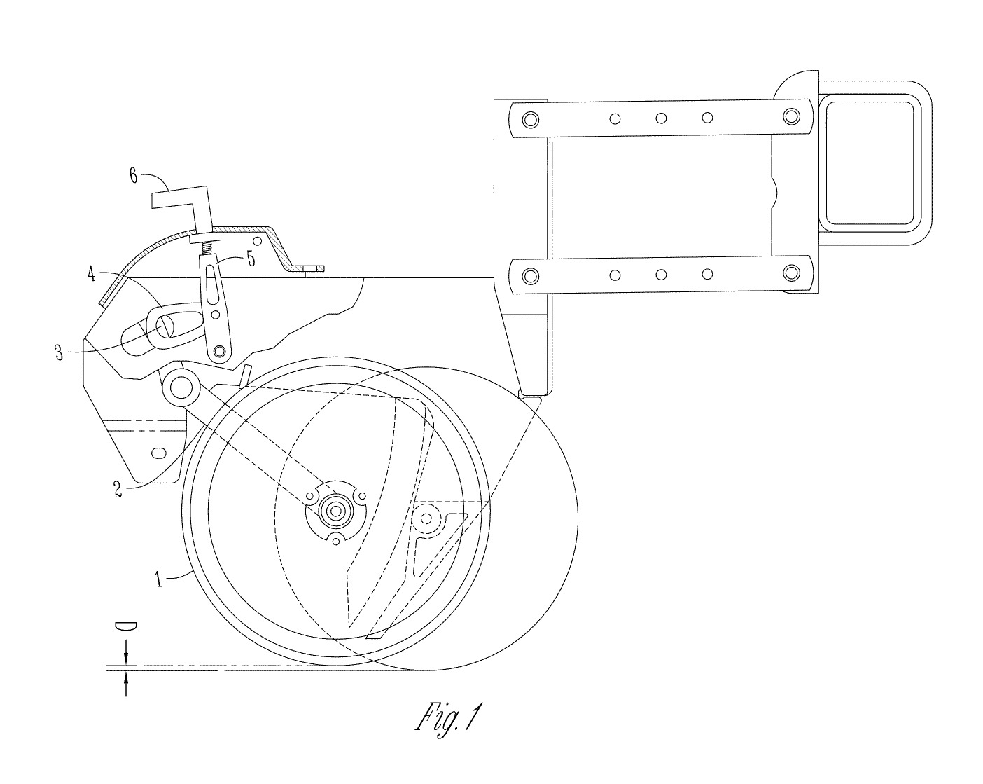

FIG. 1 shows a side view of a stock Kinze 3000 row planter.

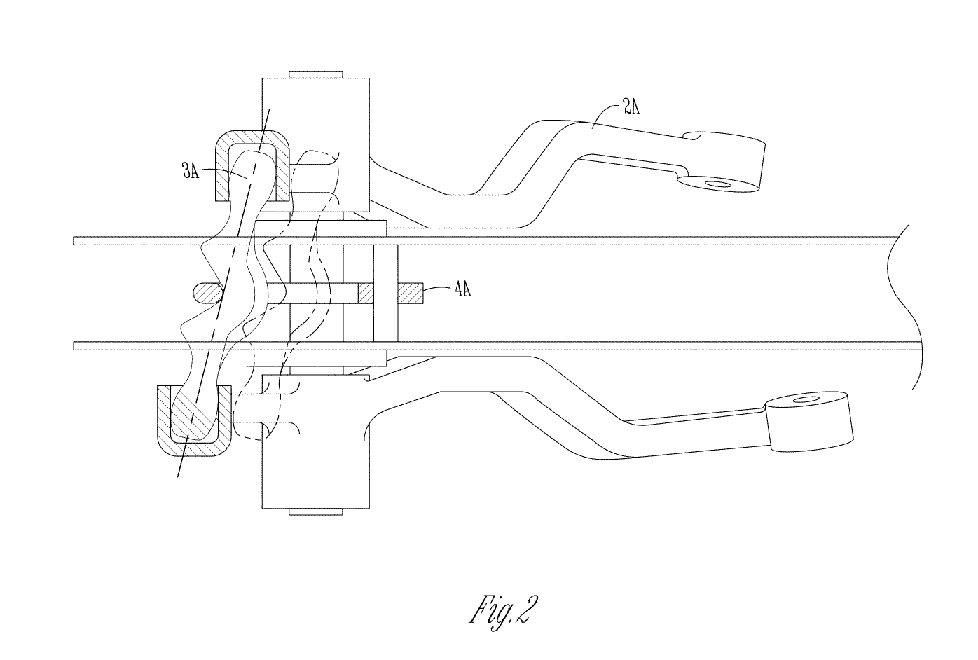

FIG. 2 shows a top view of a stock Kinze 3000 row planter. These figures illustrate the location of the depth gauge wheels [1], gauge wheel mount arms [2] [2A], saddle link [3A], yoke link [4] [4A], lever [5], and lever handle [6]. Instrumentation of any of these elements can provide a load that can be related to gauge wheel load. However, only [3], [4], [5], and [6] will yield information on the average load of both gauge wheels on a given row unit.

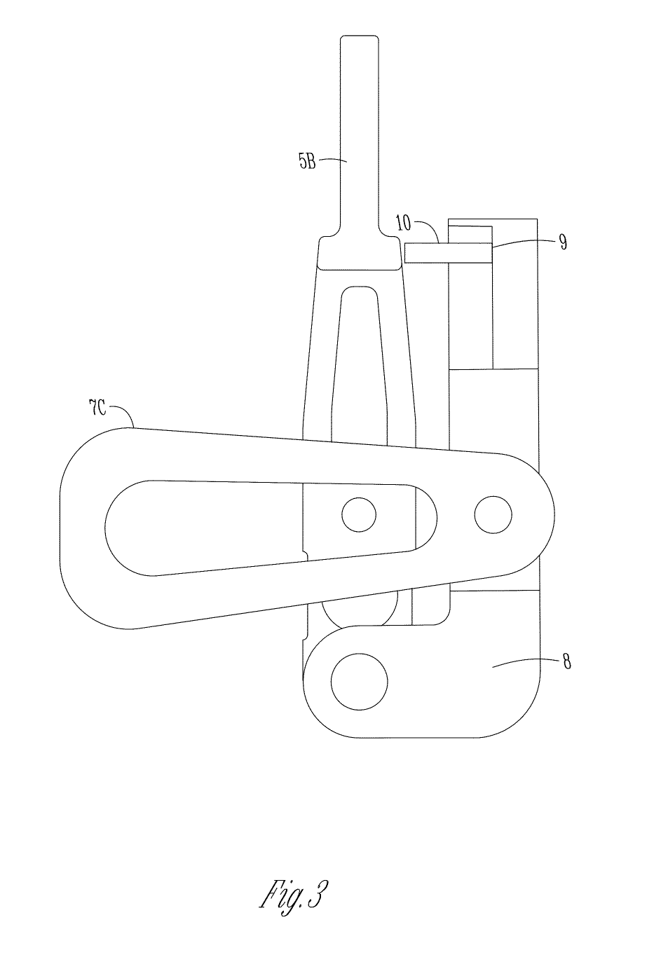

As previously explained, FIGS. 1 and 2 illustrate the linkages suitable for monitoring gauge wheel load in a Kinze planter row unit. The piezoresistive sensor may be placed in a location that provides a compressive force in a transverse fashion to the active sensor face. One such embodiment is shown in FIG. 3 where the yoke link [7c] is replaced and an additional component is mated with the lever handle [8]. The piezoresistive sensor is placed at [9], where it is subjected to compressive force between [8] and [10] when there is load on the depth gauge wheels.

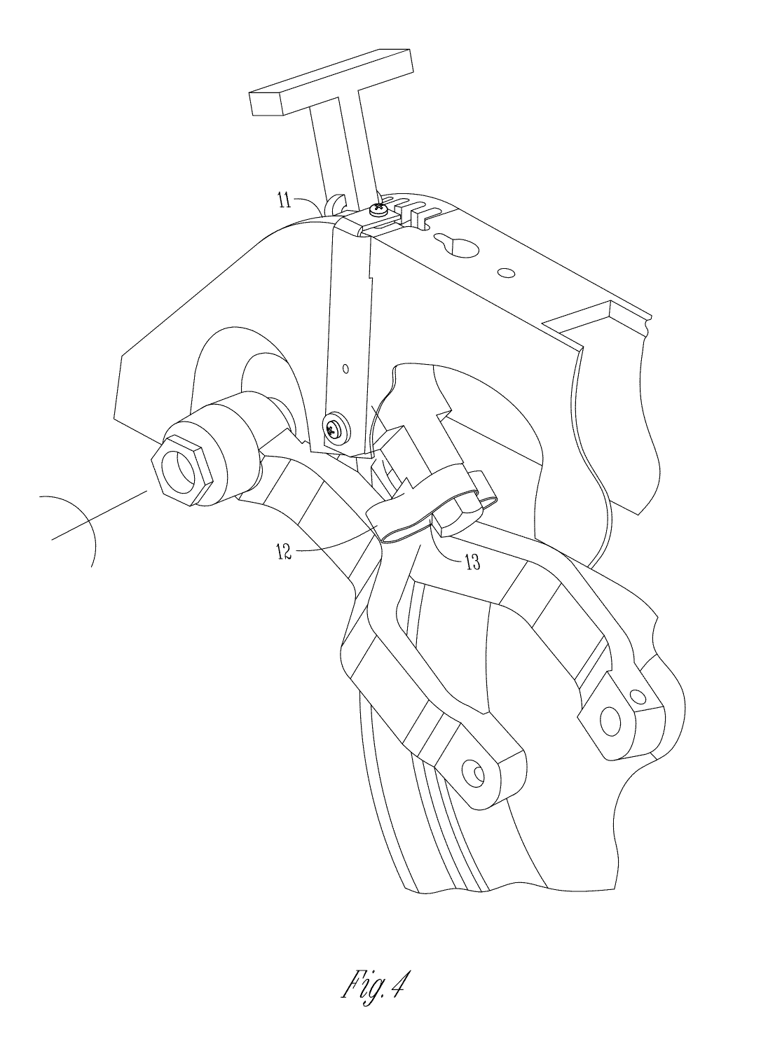

FIG. 4 illustrates the linkages suitable for monitoring gauge wheel load in a Deere planter row unit. The inventive step is the placement of the piezoresistive sensor in a location that provides a compressive force in a transverse fashion to the active sensor face. Areas of compression, suitable for sensing include [11], [12], and [13].

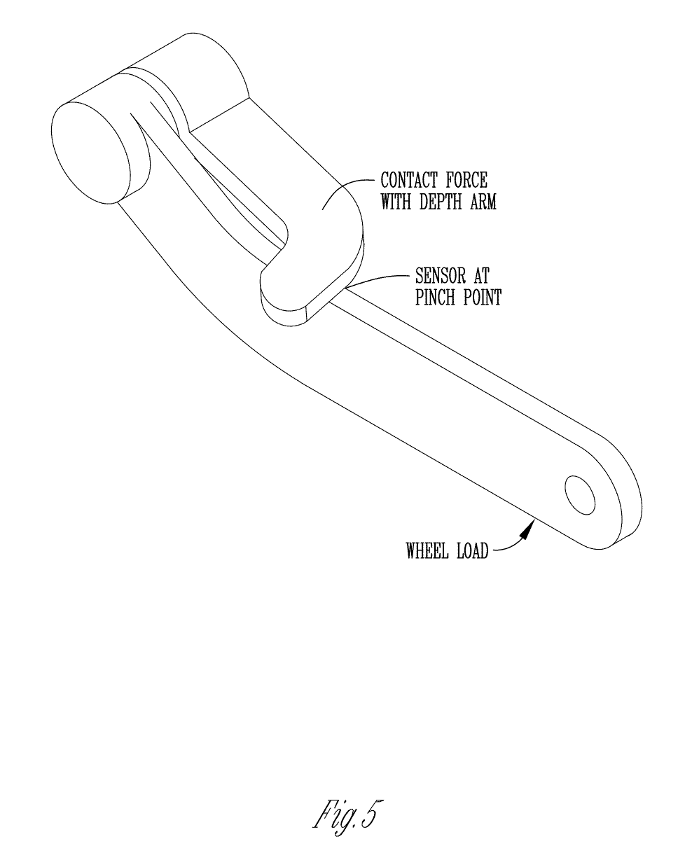

FIG. 5 illustrates a modified gauge wheel mount arm suitable for monitoring gauge wheel load in a Deere planter row unit. The inventive step is the placement of the piezoresistive sensor in the new location that provides a compressive force in a transverse fashion to the active sensor face

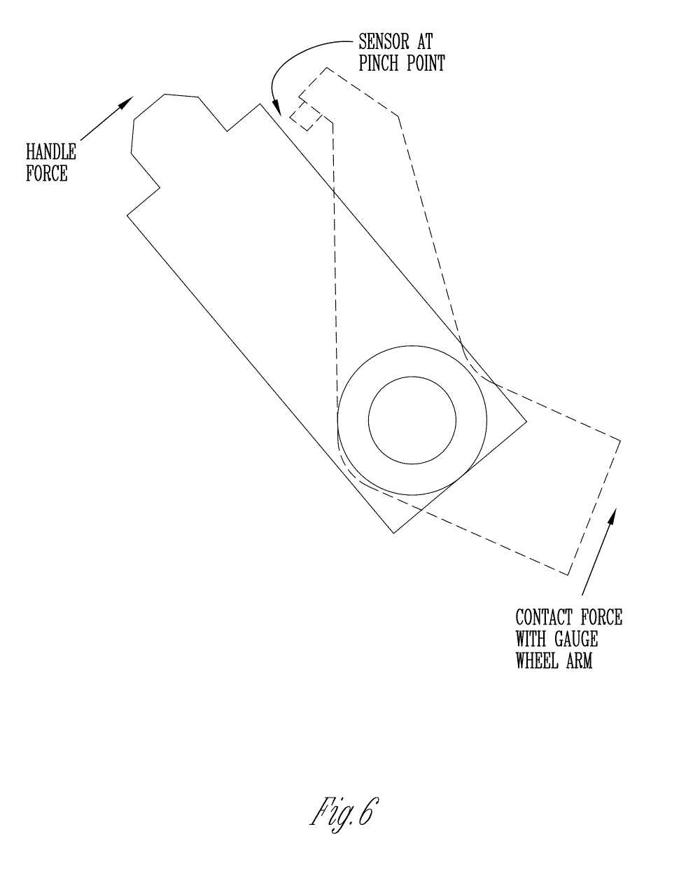

FIG. 6 illustrates a modified depth lever suitable for monitoring gauge wheel load in a Deere planter row unit. The inventive step is the placement of the piezoresistive sensor in the new location that provides a compressive force in a transverse fashion to the active sensor face

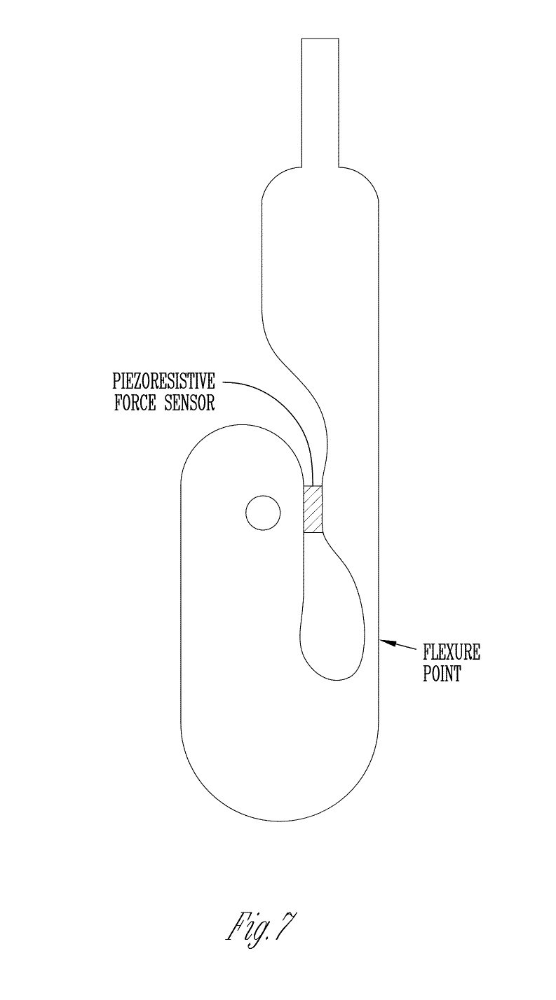

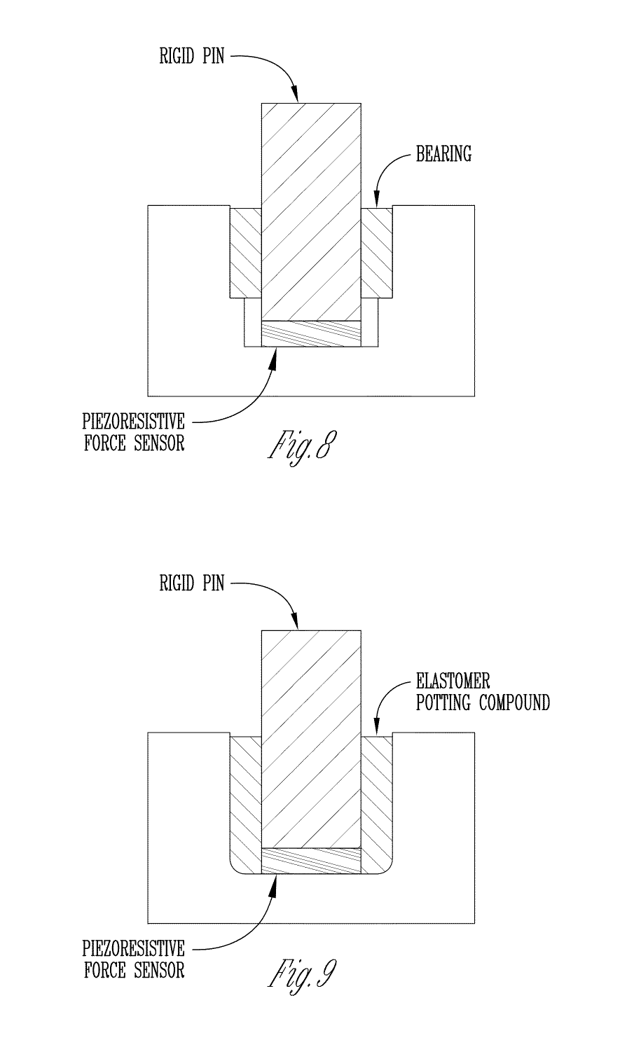

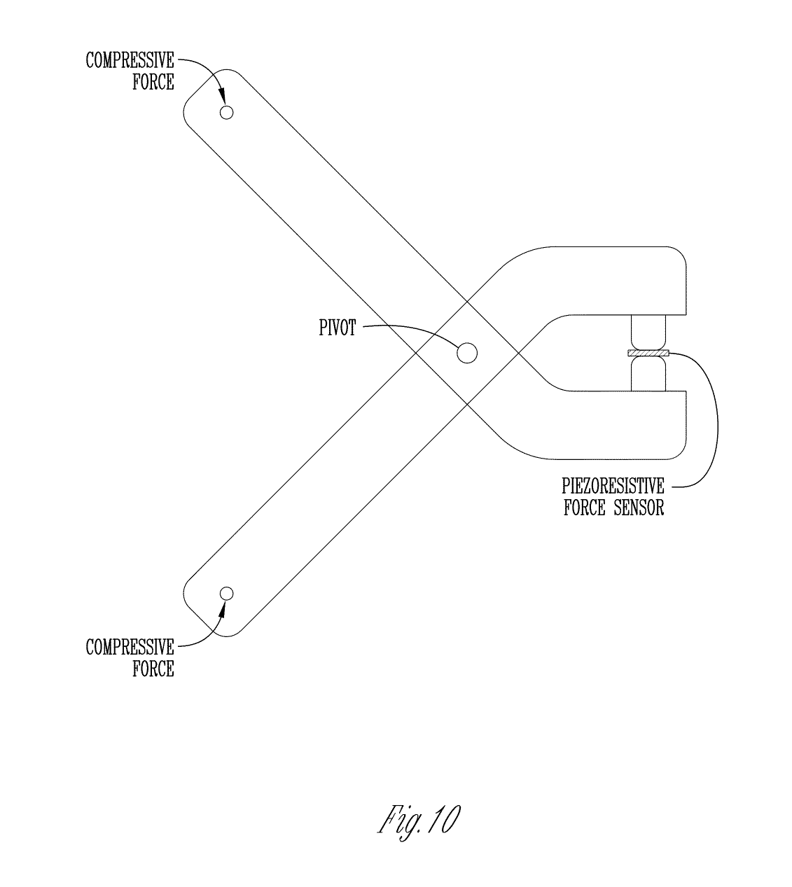

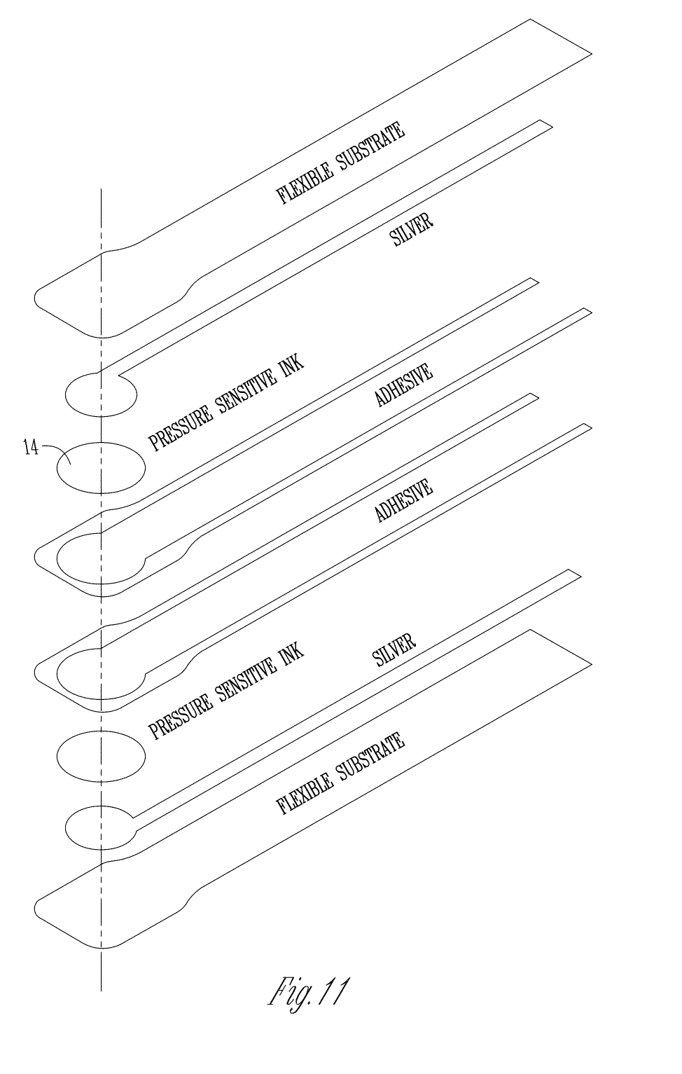

To provide accurate load measurement and extend the useful life of the sensor it is critical to eliminate shear loads and uneven load distribution due to bending. According to one aspect, a flexure, bearing guide, or potted structure is used to relieve these loads before they are passed to the sensor face. FIG. 7 shows example embodiments of a flexure; FIG. 8 a bearing guide; FIG. 9 a potted structure; and FIG. 10 a pinned scissor guide.

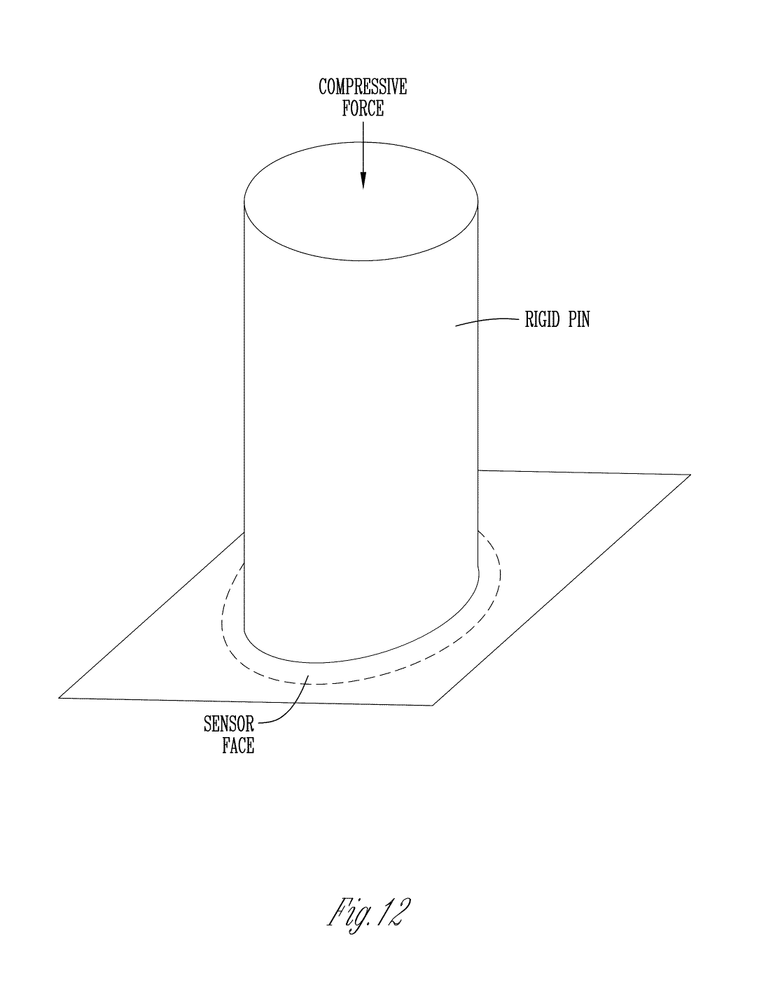

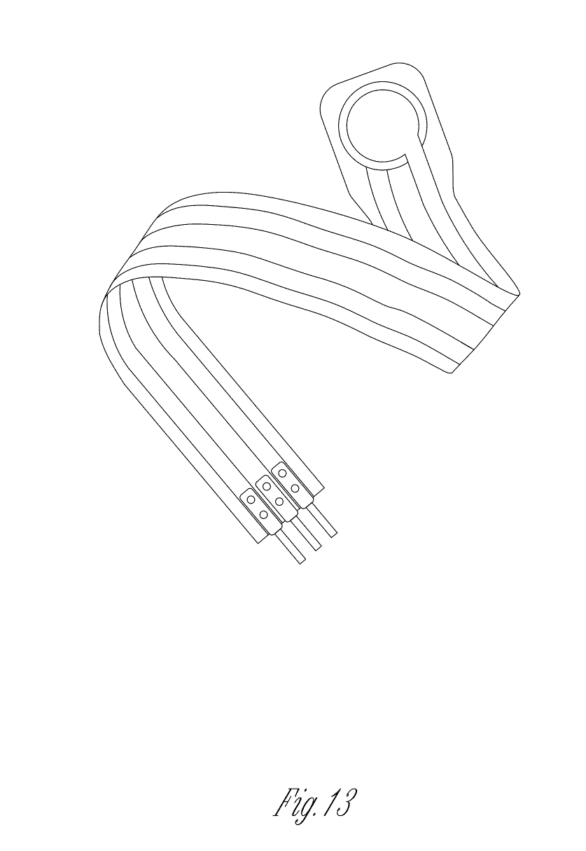

The piezoresistive sensor only responds to loads applied to the active face [14], shown in FIG. 11. A force applicator that restricts all applied force to the active face may be used. One embodiment is shown in FIG. 12.

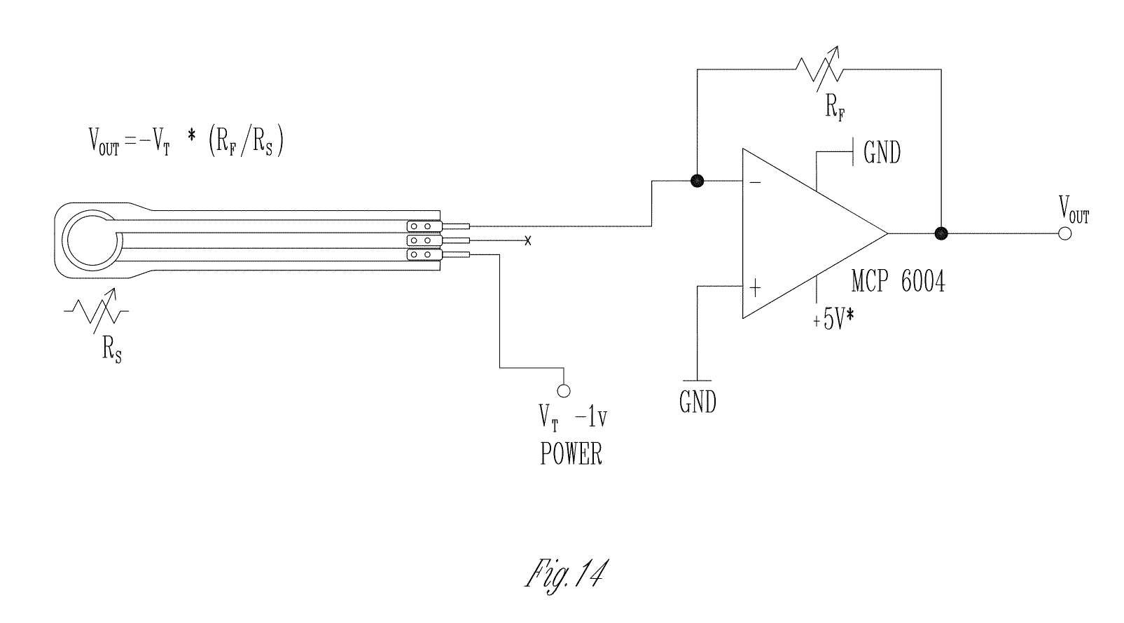

Many piezoresistive force sensors, such as the Flexiforce A201, shown in FIG. 13, use flexible circuit traces to conduct electrical signals. This is not a design suitable for the rigors of agricultural implements. The signals may be transitioned to robust wiring, such as TXL insulated wire, and encapsulating the transition to protect it from physical and environmental damage.

Piezoresistive force sensors experience a change in their resistance in response to applied force. The inventive step is the use of a basic, inexpensive amplification circuit to transform this resistance change into a signal useable by electronic monitoring circuitry. One embodiment of this amplification circuitry is shown in FIG. 14.

Therefore methods and means for monitoring forces in a planter have been described. The present invention contemplates numerous options, variations, and alternatives. For example, the present invention contemplates variations in the number of row units equipped with sensors, the placement of the sensors, the manner in which loads are relieved, and other options, variations, and alternatives such as may be appropriate to accommodate a particular planter design or control system implementation. The present invention is not to be limited to the specific embodiments described herein.

What is claimed in:

1. A method of monitoring forces in a planter, the method comprising:
measuring compressive force between contacting surfaces of a depth regulation member of the planter.

2. The method of claim 1 wherein the step of measuring compressive force between contacting surfaces of the depth regulation member is performed with a piezoresistive sensor.

3. The method of claim 2 wherein the piezoresistive sensor is positioned transversely with an active sensor face.

4. The method of claim 1 wherein a relief relieves loads before the loads are passed to a sensor face.

5. The method of claim 4 wherein the relief comprises a flexure, bearing guide, or potted structure.

6. An apparatus for monitoring force on a planter, the apparatus comprising:
a sensor positioned on the planter for measuring compressive force between contacting surfaces of a depth regulation member of the planter.

7. The apparatus of claim 6 wherein the sensor is a piezoresistive sensor.

8. The apparatus of claim 6 further comprising signal conditioning circuitry electrically connected to the sensor.

9. The apparatus of claim 6 wherein the piezoresistive sensor is positioned transversely with an active sensor face.

10. The apparatus of claim 6 further comprising a relief to relieve loads before the loads are passed to the sensor.

11. The apparatus of claim 10 wherein the relief comprises a flexure, bearing guide, or potted structure.

12. On a row-unit of an agricultural planter, an apparatus comprising:
a sensor positioned on the row-unit of the agricultural planter for measuring compressive force between contacting surfaces of a depth regulation member of the row-unit of the planter.

13. The apparatus of claim 12 wherein the sensor is a piezoresistive sensor.

14. The apparatus of claim 13 wherein the piezoresistive sensor is positioned transversely with an active sensor face.

15. The apparatus of claim 13 wherein a relief relieves loads before the loads are passed to the active sensor face.

16. The apparatus of claim 15 wherein the relief comprises a flexure, bearing guide, or potted structure.

17. The apparatus of claim 12 further comprising signal conditioning circuitry electrically connected to the sensor.
